(19) United States
(12) Patent Application Publication
(10) Pub. No.: US 2004/0196977 A1
(43) Pub. Date: Oct. 7, 2004

(54) Conveying wireless encryption keys upon client device connecting to network in non-wireless manner

(76) Inventors: Bruce L. Johnson, Eagle, ID (US); Bradley J. Anderson, Boise, ID (US); William I. Herrmann, Eagle, ID (US); Leonard T. Schroath, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/405,399

(22) Filed: Apr. 2, 2003

(51) Int. Cl. H04K 1/00

(52) U.S. Cl. 380/270

(57) ABSTRACT

An embodiment of the invention is disclosed in which a method determines whether a client device has connected to a network in a non-wireless manner. In response to determining that the client device has connected to the network in the non-wireless manner, the method conveys one or more wireless encryption keys to the client device, for the client device to use to wirelessly communicate over the network.

### BACKGROUND

Computers are commonly networked to one another. This enables them to access shared resources, such as file servers and printers, as well as enables them to communicate with one another. Traditionally, computers have been networked in a non-wireless manner. More recently, wireless networks have become popular. Wireless networks rely on wireless signals in lieu of cables to communicatively connect computers to common network components(s). Each computer in a wireless network has wireless network hardware, such as a wireless network card, which can send and receive wireless signals. Signals may be exchanged directly between two computers, or between each computer and a wireless network component, such as an access point. Wireless networks can also be combined with non-wireless networks to form hybrid networks.

Non-wireless networks have an inherent form of security in that, except at designated points that connect them to external networks such as the Internet or telecommunications networks, they are impenetrable without a physical connection into the network. By comparison, wireless and hybrid networks lack this type of security. Even if a wireless or a hybrid network is not connected to an external network, the wireless nature of such a network enables it to be penetrated without a physical network connection. For example, a hacker may attempt to access the network without having to obtain physical access to the building in which the network resides. The hacker may be able to, for instance, access the network by using a computer with a wireless network card just outside the building, such as its parking lot, a nearby street, and so on.

To overcome this security deficiency, administrators can take advantage of encryption capabilities built into most wireless networking protocols. Encryption requires that each node on a wireless network use a common encryption key to encrypt information before wirelessly transmitting it. However, using encryption in wireless networks is no security panacea. The encryption schemes are themselves vulnerable to hacker attack, and some have been successfully cracked. The encryption key is also subject to compromise. For example, users may unwittingly share the encryption key with malicious hackers, or hackers may otherwise obtain the key. Regularly changing the encryption key is desirable, but difficult to accomplish within a large organization. For these and other reasons, therefore, there is a need for the present invention.

### SUMMARY OF THE INVENTION

In an embodiment of the invention, a method determines whether a client device has connected to a network in a non-wireless manner. In response to determining that the client device has connected to the network in the non-wireless manner, the method conveys one or more wireless encryption keys to the client device, for the client device to use to wirelessly communicate over the network.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of an example hybrid network in which encryption and an access control list are employed as security measures for wireless communication, in accordance with which embodiments of the invention may be implemented.

FIG. 2 is a diagram of a hybrid network in which a client device receives a wireless encryption key and has the hardware address of its wireless network hardware added to a wireless access control list while connected in a non-wireless manner, according to an embodiment of the invention.

FIG. 3 is a diagram of a hybrid network in which a client device is connected in a wireless manner after having been connected in a non-wireless manner to receive a wireless encryption key and have the hardware address of its wireless network hardware added to a wireless access control list, according to an embodiment of the invention.

FIG. 4 is a flowchart of a method performed when a client device is connected to a hybrid wireless and non-wireless network in a non-wireless manner, according to an embodiment of the invention.

FIG. 5 is a flowchart of a method performed when a client device is connected to a hybrid wireless and non-wireless network in a wireless manner after having been connected in a non-wireless manner, according to an embodiment of the invention.

FIG. 6 is a block diagram of a server device, according to an embodiment of the invention.

FIG. 7 is a block diagram of a client device, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

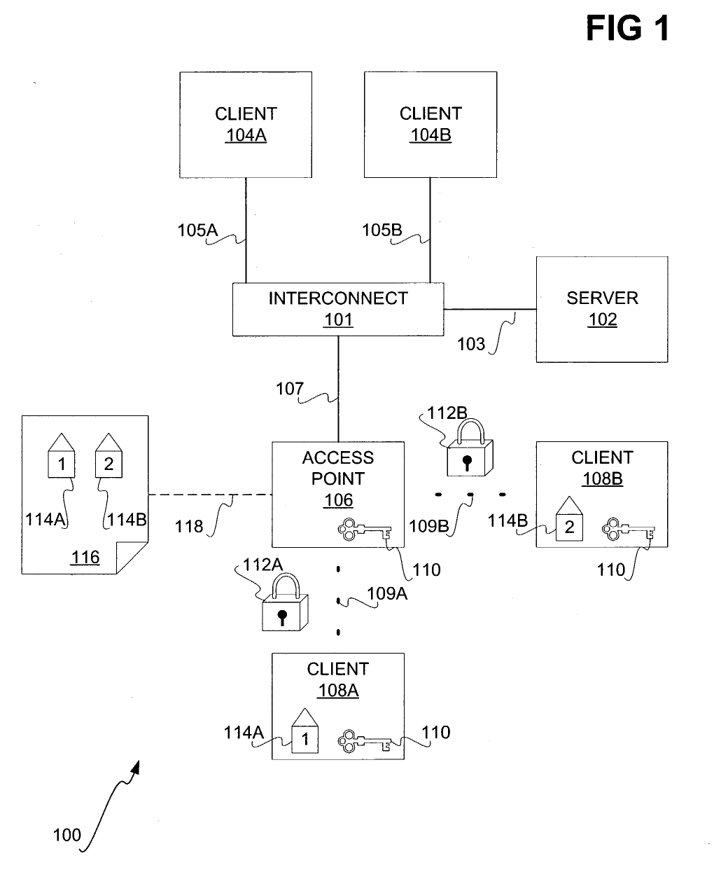

FIG. 1 shows security measures employed for wireless communication within an example hybrid wireless and non-wireless network 100, in accordance with which embodiments of the invention can be implemented. The network 100 is a hybrid network in that client devices may connect to the network 100 in either a wireless manner, a non-wireless manner, or both. The network 100 includes an interconnect 101, a server device 102, client devices 104A and 104B, an access point 106, and client devices 108A and 108B, all of which are more generally referred to as nodes. As can be appreciated by those of ordinary skill within the art, the network 100 may include nodes in addition to or in lieu of the nodes depicted in FIG. 1.

The server device 102, the client devices 104A and 104B, and the access point 106 are connected to the network 100 in a non-wireless manner. The server device 102, the client devices 104A and 104B, and the access point 106 are considered the non-wireless nodes of the network 100. These non-wireless nodes are connected to the interconnect 101 by wired connections, such as cables, as indicated by the solid lines between the nodes and the interconnect 101 in FIG. 1. For instance, the client devices 104A and 104B are connected to the interconnect 101 by the wired connections indicated by the solid lines 105A and 105B, respectively. The server device 102 is connected to the interconnect 101 by the wired connection indicated by the solid line 103, whereas the access point 106 is connected to the interconnect 101 by the wired connection indicated by the solid line 107. The interconnect 101 may include one or more hubs, routers, or other types of interconnects.

Each of the non-wireless nodes includes non-wireless network hardware that enables it to communicate information with the other nodes of the network 100 via the interconnect 101. The non-wireless network hardware may be hardware that is integrated within the node itself, or may be a network adapter card that is inserted into the node. The non-wireless network hardware may include, for instance, an Ethernet chipset, an Ethernet card, and so on. The non-wireless network hardware of each non-wireless node may have a preferably unique address, such as a media-access control (MAC) address.

The server device 102 may include a file server device, a dynamic host configuration protocol (DHCP) server device, and/or a domain name system (DNS) server device, among other types of server devices. In the case where the server device 102 is a DHCP server device, the server device 102 is able to dynamically provide the client devices 104A and 104B and the access point 106 with network identifiers, such as Internet Protocol (IP) addresses, when these nodes first connect to the network 100. In response to an announcement communication by one of the client devices 104A and 104B or the access point 106 requesting a network identifier, the server device 102 returns a network identifier that is unique within the network 100. The requesting node may provide the hardware address of its non-wireless network hardware, such as the MAC address, so that the server device 102 maintains a table of which network identifiers have been provided to which nodes by their hardware addresses.

The client devices 108A and 108B are connected to the network in a wireless manner. These nodes are connected to the access point 106 by wireless connections, such as wireless signals, as indicated by the dotted lines 109A and 109B between the client devices 108A and 108B, respectively, and the access point 106. The access point 106 serves as a transceiver that passes communication between the client devices 108 and the client devices 104 and/or the server device 102, and vice-versa. That is, the access point 106 enables wirelessly connected nodes of the network 100 to communicate with non-wirelessly connected nodes of the network 100, and vice-versa. The access point 106 may in actuality include one or more access points. The client devices 108A and 108B, and the access point 106, are considered the wireless nodes of the network 100, where the access point 106 is both a non-wireless node and a wireless node of the network 100.

Each of these wireless nodes includes wireless network hardware that enables it to communicate information with the other nodes of the network 100 via the access point 106. The wireless network hardware may be hardware that is integrated within the node itself, or may be a network adapter card that is inserted into the node. The wireless network hardware may include, for instance, a wireless Ethernet chipset, a wireless Ethernet card, and so on. The wireless Ethernet chipset or card may be compatible with the IEEE 802.11a, 802.11b, 802.11g, and/or other wireless networking standards, as can be appreciated by those of ordinary skill within the art. The wireless network hardware of each wireless node may have a preferably unique address, such as a MAC address.

The access point 106 may act as a DHCP server device for the client devices 108A and 108B, or pass announcement communications from the client devices 108A and 108B to the server device 102 and responses to these communications from the server device 102 to the client devices 108A and 108B. In either case, in response to an announcement communication by one of the client devices 108A and 108B, the requesting wireless node receives a network identifier that is unique within the network 100. The requesting wireless node may provide the hardware address of its wireless network hardware, such as the MAC address, so that the server device 102 and/or the access point 106 maintains a table of which network identifiers have been provided to which wireless nodes by their hardware addresses.

The non-wireless portion of the network 100, which includes the nodes of the network 100 that are connected to the interconnect 101 and the interconnect 101 itself, has an inherent form of security. A hacker cannot communicate with or eavesdrop on communication among the nodes without physically connecting to one of the existing nodes or the interconnect 101. Where the non-wireless portion of the network 100 is located in a secure building, for instance, this limits the extent to which hackers can intrude on the non-wireless portion of the network 100.

By comparison, the wireless portion of the network 100, which includes the access point 106 and the client devices 108A and 108B, lacks this inherent form of security. The access point 106 is part of the wireless portion of the network 100 as well as part of the non-wireless portion of the network 100 since it bridges communication from the former to the latter and vice-versa. Even if the access point 106 is located in a secure building, a hacker may be able to communicate with or eavesdrop on communication among the other nodes of the network 100 without physically penetrating the building. This is because the wireless signals that the access point 106 employs to communicate with the clients 108A and 108B are not confined to the building.

The wireless portion of the network 100 therefore utilizes at least one of two types of security to limit unauthorized access to the network 100. First, the access point 106 and the client devices 108A and 108B each share a common wireless encryption key 110. Before wirelessly communicating with one another, each of these wireless nodes encrypts the information to be communicated with the encryption key 110. The receiving node then un-encrypts the information with the same encryption key 110 upon receipt. Communication between the client devices 108A and 108B and the access point 106 is therefore encrypted, as indicated by the locked locks 112A and 112B. Even if a hacker is eavesdropping on the wireless signals exchanged among the access point 106 and the client devices 108A and 108B, the hacker will likely be unable to determine what information is being transmitted and received by these wireless nodes. The wireless encryption key 110 may be a wired equivalent privacy (WEP) encryption key.

Second, the access point 106 maintains a wireless access control list 116, as indicated by the dotted line 118, that includes the hardware addresses 114A and 114B of the wireless network hardware of the client devices 108A and 108B, respectively. The list 116 is more generally a list of wireless network hardware permitted to wirelessly communicate over the network 100. When wirelessly communicating information to the access point 106, the wireless network hardware of the client devices 108A and 108B include their hardware address 114A and 114B in the communication. When the access point 106 receives a wireless communication, it verifies that the hardware address of the wireless network hardware of the node that sent the communication is on the access control list 116. If the hardware address of the wireless network hardware is not on the list 116, then the access point 106 does not pass the communication to the other nodes of the network 100. In this way a hacker is unable to wirelessly connect to the network 100 through the access point 106.

In at least some embodiments of the invention, a client device obtains the wireless encryption key 110 and passes the hardware address of its wireless network hardware for adding to the wireless access control list 116 while the client device is connected in a non-wireless manner. When the client device subsequently connects in a wireless manner, it thus has the necessary encryption key 110 to wirelessly communicate in an encrypted and secure manner. The access point 106 also enables the client device to wirelessly communicate therewith, because the hardware address of the client device's wireless network hardware was previously added to the wireless access control list 116.

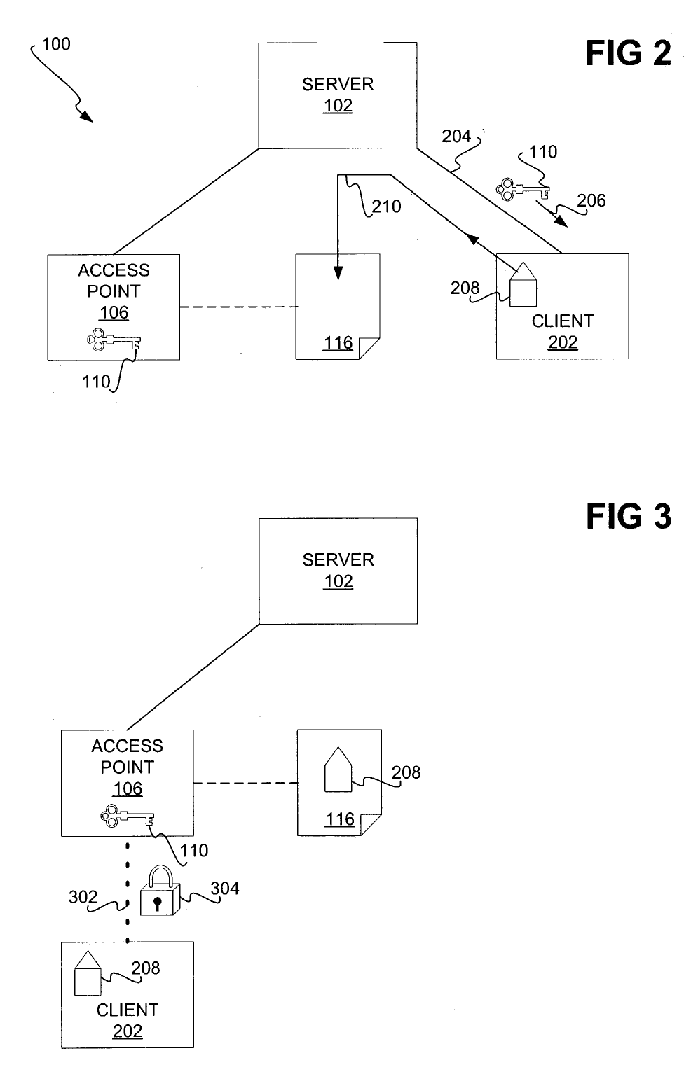

FIG. 2 shows the network 100 in which such a client device 202 initially connects to the network 100 in a non-wireless manner, according to an embodiment of the invention. The interconnect 100 and the client devices 104A, 104B, 108A, and 108B are not shown in FIG. 2 for illustrative clarity. The client device 202 has connected to the network 100 in a non-wireless manner, as indicated by the solid line 204 between the server device 102 and the client device 202. Once the client device 202 has so connected to the network 100, it provides the hardware address 208 of its wireless network hardware to the server device 102, as indicated by the line 210. The hardware address 208 may be provided as part of the announcement communication by the client device 202 requesting a network identifier from the server device 102. The server device 102 either stores the hardware address 208 on the access control list 116, or passes the hardware address 208 to the access point 106, which stores the address 208 on the list 116.

The client device 202 also receives the wireless encryption key 110 once it has connected to the network 100, as indicated by the line 206. The client device 202 may receive the wireless encryption key 110 directly from the server device 102, or from the access point 106. The wireless encryption key 110 may be provided as part of the response to the announcement communication by the client device 202 requesting a network identifier. That is, the response may include a network identifier for the client device 202 to use while it is connected to the network 100 in the non-wireless manner, as well as the wireless encryption key 110.

FIG. 3 shows the network 100 in which the client device 202 has now connected to the network 100 in a wireless manner, and is no longer connected to the network 100 in a non-wireless manner, according to an embodiment of the invention. The client device 202 is wirelessly connected to the network 100, as indicated by the dotted line 302 between the access point 106 and the client device 202. Because the hardware address 208 of the wireless network hardware of the client device 202 was previously added to the access control list 116, the access point 106 is able to validate the client device 202 and allow it to wirelessly communicate with other nodes on the network 100. Furthermore, because the client device 202 previously received the encryption key 110, it is able to have encrypted secure communication with the access point 106, as indicated by the locked lock 304.

The client device 202 receiving the wireless encryption key 110 and passing the hardware address 208 of its wireless network hardware while connected to the network 100 in a non-wireless manner, for subsequent connection to the network 100 in a wireless manner, is advantageous. Even within a network in which there are large numbers of wireless client devices, management of changing wireless encryption keys and management of the access control list 116 are easily accomplished where the wireless client devices periodically connect to the network in a non-wireless manner. For instance, the wireless encryption key may be changed without having to manually change the key in every wireless client device. As the client devices reconnect to the network in a non-wireless manner, they will receive the new key to enable them to wirelessly connect to the network.

Methods

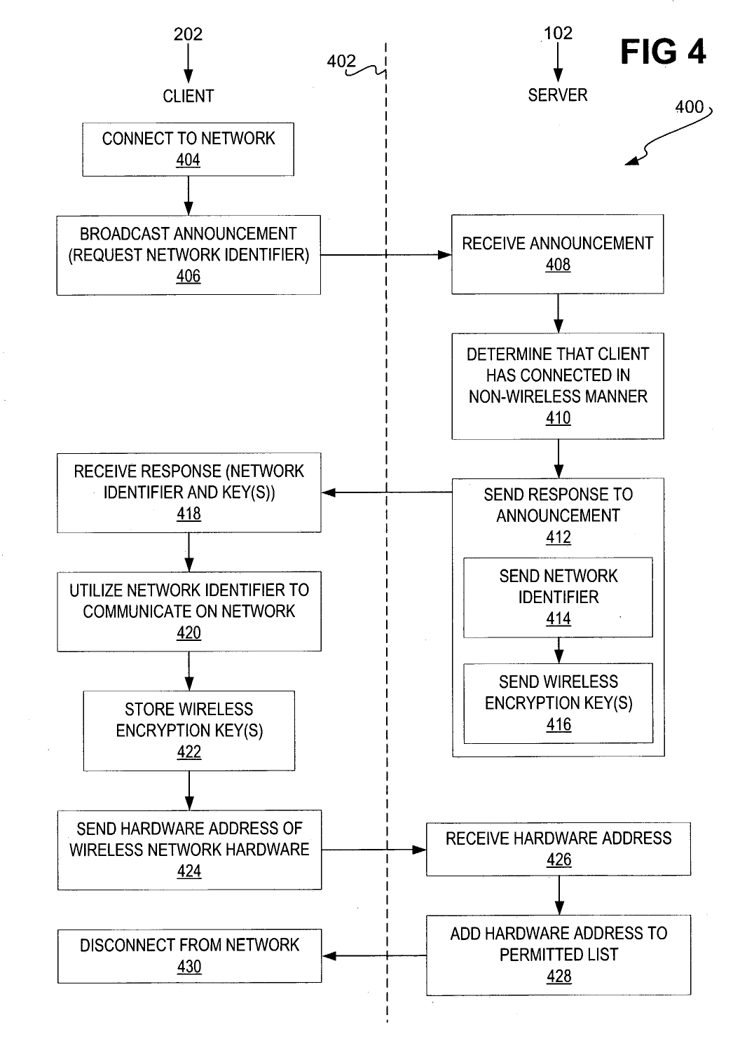

FIG. 4 shows a method 400 performed by the client device 202 and the server device 102 upon the client device 202 connecting to the network 100 in a non-wireless manner, according to an embodiment of the invention. Different parts of the method 400 are performed by the client device 202 and the server device 102, as divided by the dashed line 402. At least some parts of the method 400 can be implemented as one or more computer programs stored on a computer-readable medium, such as a volatile or a non-volatile medium, a magnetic, optical, and/or semiconductor medium, a fixed or a removable medium, and so on. For example, the medium may be a part of the firmware of the non-wireless and/or wireless network hardware of the client device 202. The computer programs may each include one or more software objects, subroutines, functions, code sections, and so on.

The client device 202 connects to the network 100 in a non-wireless manner (404). For instance, a cable may connect non-wireless network hardware of the client device 202 to the interconnect 101 of FIG. 1, or the client device 202 otherwise has its non-wireless network hardware physically connected to the network 100. Upon connecting to the network 100, the client device broadcasts an announcement communication over the network 100 (406). Within the announcement communication, the client device 202 may, for instance, request a network identifier and other network information so that the client device 202 may communicate over the network 100 while it is non-wirelessly connected to the network 100.

The server device 102 receives the announcement communication broadcast by the client device 202 (408), and determines that the client has connected in a non-wireless manner (410). For instance, the server device 102 may receive and handle the announcement communications broadcast by client devices connecting to the network 100 in a non-wireless manner, where the access point 106 may receive and handle the announcement communications broadcast by client devices connecting to the network in a wireless manner. In such a case, the server device 102 receiving the announcement communication broadcast by the client device 202 results in the server device 102 automatically concluding that the client device 202 has connected to the network 100 in a non-wireless manner.

Alternatively, the server device 102 may receive and handle the announcement communications broadcast by client devices connecting to the network 100 in either a non-wireless or a wireless manner, where the access point 106 passes the announcement communications broadcast by client devices connecting to the network 100 in a wireless manner to the server device 102. In this case, the client device 202 may have broadcast the hardware address of its non-wireless network hardware, such as a media-access control (MAC) address, as part of the broadcast communication. The server device 102 may determine that the client device 202 has connected to the network 100 in a non-wireless manner by determining that the hardware address broadcast corresponds to non-wireless network hardware, or does not correspond to wireless network hardware.

The server device 102 sends a response to the announcement communication broadcast by the client device 202 (412). This response includes at least two parts. First, the server device 102 sends a network identifier, such as an Internet Protocol (IP) address (414), for the client device 202 to utilize while it remains connected to the network 100 in a non-wireless manner. Second, the server device 102 sends, or conveys, one or more wireless encryption keys to the client device 202 (416). The wireless encryption keys include at least a currently used encryption key for encrypting wireless communication over the network 100. The wireless encryption keys may also include one or more additional encryption keys, which are the keys that will be utilized in the future, when the current encryption key expires.

The client device 202 receives the response from the server device 102 (418), specifically receiving the network identifier and the one or more wireless encryption keys. The client device 202 utilizes the network identifier to communicate over the network 100, while it remains connected to the network 100 in a non-wireless manner (420). The client device 202 also internally stores the wireless encryption keys that have been received (422). For instance, the current wireless encryption key may be employed to configure the wireless network hardware of the client device 202, whereas the future keys may be stored for later configuration of the hardware when the current key has expired. The received encryption keys may be internally stored in a manner accessible exclusively to the wireless network hardware of the client device 202, and in a user-inaccessible manner. The keys may be immediately stored in the wireless network hardware, such that they are not able to be revealed by the wireless network hardware. This ensures the security of the encryption keys without compromise.

The client device 202 next sends the hardware address of its wireless network hardware, such as the MAC address of such hardware (424). Alternatively, the hardware address of the wireless network hardware is sent during the earlier-broadcast announcement communication. The server device 102 receives the hardware address (426), and adds it to a list of wireless network hardware permitted to wirelessly communicate over the network 100 (428). This list may be the access control list 116, for instance. The access control list 116 may be maintained by the access point 106, such that the server device 102 passes the hardware address of the wireless network hardware of the client device 202 to the access point 106 for adding to the list 116. Ultimately, the client device 202 disconnects from the network 100 in the non-wireless manner (430).

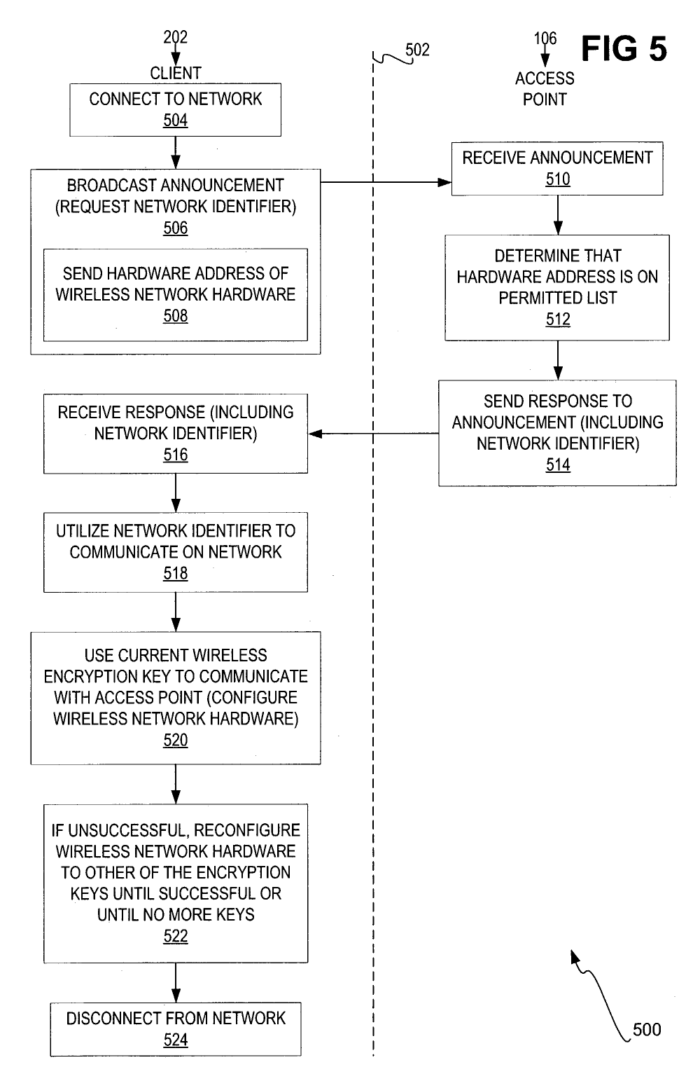

FIG. 5 shows a method 500 performed by the client device 202 and the access point 106 upon the client device 202 connecting to the network 100 in a wireless manner, according to an embodiment of the invention. The method 500 is preferably performed after the method 400 of FIG. 4 has been performed. Different parts of the method 500 are performed by the client device 202 and the access point 106, as divided by the dashed line 502. Like the method 400, at least some parts of the method 500 can be implemented as one or more computer programs stored on a computer-readable medium.

The client device 202 connects to the network 100 in a wireless manner (504). The wireless network hardware of the client device 202 thus sends wireless signals that are received by the access point 106. The client device 202 broadcasts an announcement communication over the network 100 (506), in which it requests a network identifier and other network information so that the client device 202 may communicate over the network 100 while it remains wirelessly connected to the network 100. As part of this announcement communication, the client device 202 sends the hardware address of its wireless network hardware (508).

The access point 106 receives the announcement communication broadcast by the client device 202 (510), and determines that the hardware address of the wireless network hardware of the client device 202 is on the access control list 116 (512). Assuming that the hardware address of the wireless network hardware of the client device 202 is on the list 116, the access point 106 sends a response to the announcement communication broadcast by the client device 202 that includes a network identifier (514). The access point 106 may be able to determine the network identifier itself, or it may request that the server device 102 determine the network identifier for the access point 106 to convey to the client device 202. The client device 202 receives the response, including the network identifier (516), and utilizes the network identifier to communicate over the network 100 (518).

When communicating with the access point 106, the client device 202 utilizes the current wireless encryption key to encrypt the information it sends and un-encrypt the information it receives (520). The client device 202 initially configures the wireless network hardware to the current encryption key if this has not already been accomplished previously. If the client device 202 is unsuccessful in communicating with the access point 106, then it reconfigures the wireless network hardware to one of the future encryption keys, until the client device 202 can successfully communicate with the access point 106, or it has run out of encryption keys (522).

That is, if the current encryption key does not allow the client device 202 to communicate with the access point 106, then the client device 202 concludes that this key has expired, and tries the other keys instead. Either one of the other keys will allow the client device 202 to communicate with the access point 106, or none will, in which case the device 202 may have to reconnect with the network 100 in a non-wireless manner to obtain one or more new keys. Ultimately, the client device 202 disconnects from the network 100 in a non-wireless manner (524).

Server Device and Client Device

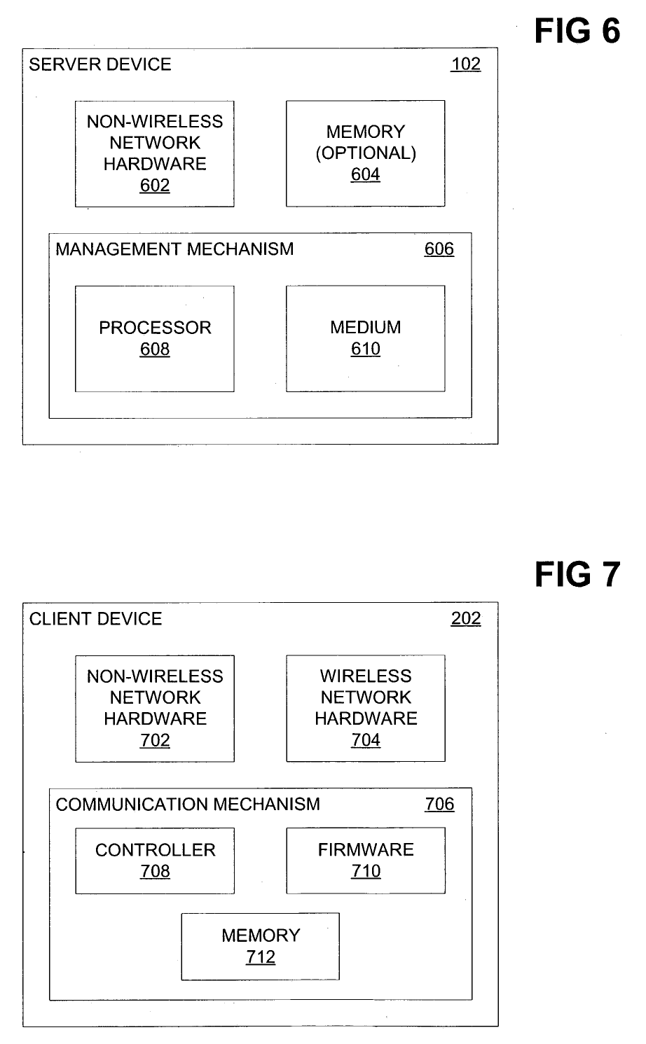

FIG. 6 shows the server device 102 in detail, according to a specific embodiment of the invention. The server device 102 includes non-wireless network hardware 602, an optional memory 604, and a management mechanism 606, the latter which includes a processor 608 and a computer-readable medium 610. As can be appreciated by those of ordinary skill within the art, the server device 102 may include components in addition to and/or in lieu of the components depicted in FIG. 6.

The non-wireless network hardware 602 is configurable to connect to the network 100 in a non-wireless manner. The hardware 602 may thus include Ethernet chipsets, Ethernet network adapter cards, and/or other types of network connectivity chipsets and network connectivity network adapter cards. The non-wireless manner presumes a physical connection between the network hardware 602 and the network 100. For instance, one or more cables may connect the network hardware 602 to the network 100.

The management mechanism 606 is operatively connected to the non-wireless network hardware 602, and can in one embodiment include the processor 608 and the computer-readable medium 610. The management mechanism 606 is configured to convey one or more wireless encryption keys to client devices capable of both wireless and non-wireless network communication, upon connection of such client devices to the network 100 in a non-wireless manner. Thus, the medium 610 may store one or more computer programs to effectuate this functionality, which are performed by the processor 608. The mechanism 606 may further be configured to receive hardware addresses of wireless network hardware of the client devices and add the addresses to a list of wireless network hardware permitted to wirelessly communicate over the network 100, such as the access control list 116.

The memory 604 is operatively coupled to the management mechanism 606. The memory 604 is configured to store the wireless encryption keys and/or the access control list 116. Alternatively, the wireless encryption keys may be stored at a device other than the server device 102, such that the memory 604 does not store the encryption keys. For instance, the access point 106 may store the encryption keys. Similarly, the access control list 116 may be stored at a device other than the server device 102, such that the memory 604 does not store the access control list 116. For instance, the access point 106 may store the access control list 116.

FIG. 7 shows the client device 202 in detail, according to a specific embodiment of the invention. The client device 202 includes non-wireless network hardware 702, wireless network hardware 704, and a communication mechanism 706, the latter which includes a controller 708, firmware 710, and a memory 712. As can be appreciated by those of ordinary skill within the art, the client device 202 may include components in addition to and/or in lieu of the components depicted in FIG. 7.

The non-wireless network hardware 702 is configurable to connect to the network 100 in a non-wireless manner, whereas the wireless network hardware 704 is configurable to wirelessly connect to the network using a wireless encryption key, such as the encryption key 110. The hardware 702 may thus include Ethernet chipsets, Ethernet network adapter cards, and/or other types of network connectivity chipsets and network connectivity network adapter cards. The non-wireless manner of connection to the network 100 presumes a physical connection between the hardware 702 and the network 100. The hardware 704 may include wireless Ethernet chipsets, wireless Ethernet network adapter cards, and/or other types of wireless network connectivity chipsets and wireless network connectivity network adapter cards. If there is more than one wireless encryption key, the wireless network hardware 704 may be configured to automatically wirelessly connect to the network 100 using another encryption key where connection to the network 100 using a current key is unsuccessful.

The communication mechanism 706 is operatively connected to both the non-wireless network hardware 702 and the wireless network hardware 704, and can in one embodiment include the controller 708, such as a processor, the firmware 710, or another type of computer-readable medium, and the memory 712. The communication mechanism 706 is configured to retrieve one or more encryption keys, including the wireless encryption key 110, over the network 100 upon connection to the network 100 in the non-wireless manner via the non-wireless network hardware 702. The mechanism 716 is also configured to convey a hardware address of the wireless network hardware 704 over the network 100 upon connection to the network 100 in the non-wireless manner. The memory 712 may be configured to store the one or more encryption keys, including the encryption key 110. The communication mechanism 706 may be integrated with the non-wireless network hardware 702 and/or the wireless network hardware 704 in one embodiment of the invention.

### CONCLUSION

It is noted that, although specific embodiments have been illustrated and described herein, it will be appreciated by those of ordinary skill in the art that any arrangement that is calculated to achieve the same purpose may be substituted for the specific embodiments shown. This application is thus intended to cover any adaptations or variations of the present invention. Therefore, it is manifestly intended that this invention be limited only by the claims and equivalents thereof.

We claim:

1. A method comprising:
determining whether a client device has connected to a network in a non-wireless manner; and,
in response to determining that the client device has connected to the network in the non-wireless manner, conveying one or more wireless encryption keys to the client device for the client device to use to wirelessly communicate over the network.

2. The method of claim 1, further comprising receiving from the client device an announcement communication in which the client device has requested network information including a network identifier,
wherein determining whether the client device has connected to the network in the non-wireless manner comprises automatically concluding that the client device has connected to the network in the non-wireless manner in response to receiving the announcement communication from the client device.

3. The method of claim 1, further comprising receiving from the client device a hardware address of network hardware of the client device used by the client device to connect to the network,
wherein determining whether the client device has connected to the network in the non-wireless manner comprises concluding that the client device has connected to the network in the non-wireless manner in response to determining that the hardware address of the network hardware corresponds to non-wireless network hardware.

4. The method of claim 1, further comprising:
receiving from the client device a hardware address of wireless network hardware of the client device; and,
adding the hardware address of the wireless network hardware of the client device to a list of wireless network hardware permitted to wirelessly communicate over the network.

5. The method of claim 1, wherein conveying the one or more wireless encryption keys to the client device comprises conveying a currently used encryption key for the client device to use to wirelessly communicate over the network.

6. The method of claim 5, wherein conveying the one or more wireless encryption keys to the client device further comprises conveying one or more future encryption keys for the client device to use to wirelessly communicate over the network when the currently used encryption key has expired.

7. A method comprising:
connecting to a network in a non-wireless manner;
receiving over the network one or more wireless encryption keys to use to wirelessly communicate over the network; and,
storing internally the one or more wireless encryption keys to use to subsequently wirelessly communicate over the network.

8. The method of claim 7, further comprising sending over the network an announcement communication in which network information including a network identifier is requested,
wherein the one or more wireless encryption keys are received as part of a response to the announcement communication.

9. The method of claim 7, further comprising sending over the network a hardware address of wireless network hardware to be used to subsequently wirelessly communicate over the network.

10. The method of claim 7, wherein connecting to the network in the non-wireless manner comprises physically connecting network hardware to the network.

11. The method of claim 7, wherein receiving over the network one or more wireless encryption keys comprises receiving a currently used encryption key to use to wirelessly communicate over the network.

12. The method of claim 11, wherein storing internally the one or more wireless encryption keys comprises configuring wireless network hardware to the currently used encryption key.

13. The method of claim 11, wherein receiving over the network one or more wireless encryption keys further comprises receiving one or more future encryption keys to use to wirelessly communicate over the network when the currently used encryption key has expired.

14. The method of claim 13, wherein storing internally the one or more wireless encryption keys comprises storing the one or more future encryption keys for configuring wireless network hardware thereto when the currently used encryption key has expired.

15. The method of claim 7, wherein storing internally the one or more wireless encryption keys comprises storing the encryption keys in a manner exclusively accessible to wireless network hardware.

16. The method of claim 7, wherein storing internally the one or more wireless encryption keys comprises storing the encryption keys in a user-inaccessible manner.

17. A computer-readable medium having a computer program stored thereon to perform a method comprising:
while connected to a network in a non-wireless manner, receiving over the network one or more wireless encryption keys to wirelessly communicate over the network, and,
wirelessly connecting to the network and communicating over the network using the one or more wireless encryption keys.

18. The medium of claim 17, wherein the method further comprises disconnecting from the network in the non-wireless manner.

19. The medium of claim 17, wherein receiving over the network the one or more wireless encryption keys while connected to the network in the non-wireless manner comprises receiving a currently used encryption key, and wherein wirelessly communicating over the network comprises configuring wireless network hardware to the currently used encryption key.

20. The medium of claim 19, wherein receiving over the network the one or more wireless encryption keys while connected to the network in the non-wireless manner further comprises receiving one or more future encryption keys.

21. The medium of claim 20, wherein the method further comprises, where wirelessly communicating over the network is unsuccessful after configuring the wireless network hardware to the currently used encryption key, reconfiguring the wireless network hardware to one of the one or more future encryption keys.

22. A server device for a network comprising:
non-wireless network hardware configurable to connect to the network in a non-wireless manner; and,
a management mechanism operatively coupled to the non-wireless hardware and configured to convey one or more wireless encryption keys to client devices capable of wireless and non-wireless network communication upon connection thereof to the network in the non-wireless manner.

23. The server device of claim 22, further comprising a memory operatively coupled to the management mechanism and configured to store the one or more wireless encryption keys.

24. The server device of claim 22, wherein the one or more wireless encryption keys are storable at a device other than the server device and connected to the network in at least the non-wireless manner.

25. The server device of claim 22, wherein the management mechanism is further configured to receive hardware addresses of wireless network hardware of the client devices and to add the hardware addresses to a list of wireless network hardware permitted to wirelessly communicate over the network.

26. The server device of claim 25, further comprising a memory operatively coupled to the management mechanism and configured to store the list of wireless network hardware permitted to wirelessly communicate over the network.

27. The server device of claim 25, wherein the list of wireless network hardware permitted to wirelessly communicate over the network is storable at a device other than the server device and connected to the network in at least the non-wireless manner.

28. A server device for a network comprising:
means for connecting to the network; and,
means for conveying one or more wireless encryption keys to client devices capable of wireless and non-wireless network communication upon connection thereof to the network in a non-wireless manner.

29. A client device for a network comprising:
non-wireless network hardware configurable to connect to the network in a non-wireless manner;
wireless network hardware configurable to wirelessly connect to the network using a wireless encryption key; and,
a communication mechanism operatively coupled to the non-wireless network hardware and the wireless network hardware and configured to retrieve the wireless encryption key over the network upon connection thereto in the non-wireless manner.

30. The client device of claim 29, wherein the communication mechanism comprises a memory configured to store one or more wireless encryption keys including the wireless encryption key and to allow exclusive access thereto by the wireless network hardware.

31. The client device of claim 29, wherein the communication mechanism is integrated with at least one of the wireless network hardware and the non-wireless network hardware.

32. The client device of claim 29, wherein the communication mechanism is further configured to convey a hardware address of the wireless network hardware over the network upon connection thereto in the non-wireless manner.

33. The client device of claim 29, wherein the communication mechanism is further configured to retrieve one or more additional encryption keys over the network upon connection thereto in the non-wireless manner.

34. The client device of claim 33, wherein the wireless network hardware is further configurable to automatically wirelessly connect to the network using one of the one or more additional encryption keys where wireless connection to the network using the wireless encryption key is unsuccessful.

35. A client device for a network comprising:
wired means for connecting to the network in a non-wireless manner;
wireless means for wirelessly connecting to the network; and,
means for retrieving a wireless encryption key over the network upon connection thereto in the non-wireless manner and for configuring the wireless means to the wireless encryption key.
